(19) United States
(12) Patent Application Publication
(10) Pub. No.: US 2021/0355013 A1
(43) Pub. Date: Nov. 18, 2021

(54) SLUDGE DEWATERING SYSTEM

(71) Applicant: PARK TEQ, LLC, Houston, TX (US)

(72) Inventor: C. Russell CAUGHMAN, Houston, TX (US)

(21) Appl. No.: 17/231,146

(22) Filed: Apr. 15, 2021

Related U.S. Application Data
(60) Provisional application No. 63/010,151, filed on Apr. 15, 2020.

(51) Int. Cl. C02F 11/128

(52) U.S. Cl. CPC C02F 11/128; C02F 2201/005

(57) ABSTRACT

A sludge dewatering system has a container having an interior volume and a floor, a plurality of filtration panels positioned in the interior volume of the container, and a plastic panel. Each of the plurality of filtration panels has an expanded metal panel and a filter media extending along a surface of the expanded metal panel. The filter media has a portion extending outwardly beyond a bottom of the frame. The portion extends outwardly so as to reside generally against the floor of the container. The plastic panel overlies the portion of the filter media and resides over a portion of the floor of the container.

### RELATED U.S. APPLICATIONS

The present application claims priority from U.S. patent Provisional application Ser. No. 63/010,151, filed on Apr. 15, 2020, and entitled “Sludge Dewatering System”.

### BACKGROUND OF THE INVENTION

### 1. Field of the Invention

The present invention relates to systems that remove water from sludge. More particularly, the present invention relates to transportable containers that allow sludge to be transported to a landfill. More particularly, the present invention relates to sludge filtration systems that effectively remove water from the sludge.

### 2. Description of Related Art Including Information Disclosed Under 37 CFR 1.97 And 37 CFR 1.98

The term “sludge” is usable to refer to a variety of solid-liquid mixtures, including slurries, emulsions, or any similar mixture, such as sewage, industrial waste, or contaminated mud. A sludge can contain any number of liquid or solid components, and can have any ratio of liquid to solid. Typically, a sludge has somewhat more liquid than solid material contained therein. Due to the inherent properties of solid-liquid mixtures, many difficulties exist related to their handling, treatment, disposal.

Environmental regulations require that prior to disposal of a sludge in a landfill, the water content of the sludge should be reduced to an acceptable level. Additionally, a solid-liquid mixture containing a significant quantity of liquid is considered heavier than a mixture from which some or all of the liquid has been removed. This causes transport of the mixture to be difficult and cumbersome. Often, freight carriers and other transporters of a sludge, or similar solid-liquid mixture, assess costs based on the weight of the material transported. Also, water (when separated from the solids) can be easily discharged into a sewer at little or no cost. When the sludge is drier, it is cheaper to haul and easier to dispose. As such, a need has developed to provide a drier product from sludge.

To facilitate efficient and less expensive transport and disposal of solid-liquid mixtures, while complying with environmental regulations, various types of solid-liquid separators have been used to remove the liquid components of the mixture from the solid media. Additionally, the separation of the solid-liquid mixtures has many noteworthy industrial applications where it is desirable to retain one or more solid or liquid components for treatment, analysis, processing or use.

Generally, separation of a solid-liquid mixture is accomplished through filtration, using either pressure drainage or gravitational drainage. Vacuum drainage requires use of an on-site pump to draw liquid through a filter. This necessitates the use of a filtrate cavity that remains beneath the surface of the liquid throughout the filtering process. The force of the pump draws solid particles, as well as the liquid portion of the mixture, toward the filter. This can cause blockage of the filter and reduce the speed and efficiency of the separation process. The solid cake tends to stick to the filter when dumping.

Gravitational drainage involves simply placing a solid-liquid mixture into a container having one or more filters therein and allowing gravity to pull the liquid through the filters while the solid material is retained. The solid-liquid mixture is normally flocculated using one or more suitable polymers prior to filtration. This facilitates the separation of the mixture. Often, a number of polymers are tested against a waste source or other source of the solid-liquid mixture to determine which polymer will be the most effective for flocculating the mixture. Since no vacuum pumping is required for gravitational drainage, it is not necessary to retain the filtrate cavity beneath the liquid level of the sludge. Filters extending throughout the entire height of the container can be used to maximize surface area for the separation process and minimize the potential for blockage of filter.

However, gravitational drainage is an extremely slow process. Additionally, due to uneven distribution of the sludge within a container, and uneven rates of drainage for different portions of the sludge, it is common for large quantities of liquid to be retained in certain portions of the container for significant length of time while other portions of the liquid are separated more rapidly. Additionally, it is known that the liquid will tend to accumulate at the bottom of the container by virtue of gravity and the internal structures of the container. Typically, the filtration panels are supported by a frame that has a lip or a bar extending upwardly from a bottom of the container. As such, during the filtration process, a pool of water will tend to accumulate in this area within the container. Since landfill regulations restrict the amount of water that can be discharged into the landfill, it is important to be able to transport the sludge while avoiding the accumulation of a pool of liquid at the bottom of the container.

In the past, various patents of issued with respect to sludge filtration systems. For example, U.S. Pat. No. 4,426,020, issued on Jan. 17, 1984 to Perssau et al., describes a portable container for use in handling sludge. The container has a bottom wall and enclosing the walls. The bottom wall has a drainage area for passing liquid from the sludge placed in the container. The bottom wall is shaped to direct liquid from the sludge to the drainage area.

U.S. Pat. No. 4,871,454, issued on Oct. 3, 1989 to W. G. Lott, shows a portable dumpster and slurry separating system. In particular, this is an apparatus for separating solids from a liquid of a sludge or slurry using a peristaltic pump in order to pull a vacuum on the sludge. The apparatus includes a slurry source, a slurry container receiving the slurry from the source, and a filter cage removably mounted inside the container. The filter cage includes a cage frame, a supported screen liner mounted within the cage and a filter liner removably fitted inside the liner. The container has a liquid drainage conduit removably connected to a suction device for removing liquid from the drainage chamber. The container is constructed and adapted to be picked up, carried about, and tilted to remove solid material deposited within the filter cage.

U.S. Pat. No. 4,975,205, issued on Dec. 4, 1990 to A. H. Sloan, provides an apparatus for receiving, draining and disposing of dredged material. A dump truck is provided that has a tiltable dump body with a tailgate at a rear end thereof. A partition or weir is mounted in the dump body and is of lesser height than the walls of the dump body so as to divide the dump body into front and rear compartments. A siphon is connected between the two compartments and extends over the partition. The rear compartment receives dredged material in the form of a mixture of water and sand pumped thereinto through a supply conduit on the dump body. As the rear compartment is being filled with dredged material, gravity causes the sand to settle at the bottom and the water to rise to the top and spill over the partition into the front compartment.

U.S. Pat. No. 5,232,599, issued on Aug. 3, 1993 to C. M. Cole, describes a device and method for preparing sludge for disposal. This device comprises a box with a thin layer of gravel on the bottom and a thin layer sand on the gravel layer. There is an array of perforated piping deployed throughout the gravel layer. A sump is located in the gravel layer before the purpose perforated pipe array. Standpipes connect the array and sump to an external ion exchanger/fine particulate filter and a pump. Sand is deposited on the sand layer and dewatered using a pump connected to the piping array.

U.S. Pat. No. 5,589,081, issued on Dec. 31, 1996 to R. B. Harris, teaches a divided phase separator for liquid/solid separation in sludge. The separator tank has a bed with a drain, surrounding sides and a dividing wall. A grate overlays the interior of the vessel, bed and sides so as to form the dividing wall. A filter overlays the grate, extending up from the sides and overlapping the side grate and covering the dividing wall. The separator is filled with a sludge which is then separated from the liquid by gravity and hydrostatic pressure so as to force the liquid through the filter. Liquid is strained out of the bottom of the vessel and the solids are transported within the vessel. The solids are removed through a gate that may be provided in the tank or by using a hydraulic lift system. The filter is dumped along with the solid cake.

U.S. Pat. No. 5,681,460, issued on Oct. 28, 1997 to the present inventor, shows a selectively removable sludge filtration system that provides for retrofit into a container and separation of the sludge solids from the sludge liquids therein. A pair of spaced vertically-oriented filter assemblies each define a filtrate cavity therein that are connected by separator plates. The filter assemblies permit the flow of sludge liquids into the filtrate cavity. A set of fasteners hold the filter assemblies in the container and bias the filter assemblies against the container bottom. The fasteners may be released to provide for removal of the sludge filtration system from the container.

U.S. Pat. No. 6,146,528, issued on Nov. 18, 2000 to the present inventor, discloses a sludge filtration system that includes a container, a first filter assembly defining a first filtrate cavity, a first device for evacuating the sludge filtrate from the first filtrate cavity, and a device for selectively slidably removing the first filter assembly from the container. The container can be either an open-top box or a vacuum box that is constructed to receive sludge therein. The system further includes a second filter assembly defining a second filtrate cavity. The second filter assembly is attached to the first filter assembly and extends from the first filter assembly in a direction distal to the bottom of the container.

U.S. Pat. No. 7,179,377, issued on Feb. 20, 2007 to the present inventor, discloses a sludge filter that is comprised of mesh filter media secured to a support net. The support net includes a front surface adjacent to the filter media and a rear surface opposite the filter media. The rear surface has a plurality of outwardly extending nodes to define flow channels for horizontal and vertical fluid flow intermediate the net and a container surface. The sludge filter is attached directly to the walls or floor of the container.

U.S. Pat. No. 7,820,045, issued on Oct. 26, 2010, describes a filter for sludge filtration. The sludge filter is comprised of a mesh filter media secured to a support net. The support net includes a first surface adjacent the filter media and a rear surface opposite the filter media. The rear surface has a plurality of outwardly extending nodes to define flow channels for horizontal and vertical fluid flow intermediate the net in a container surface. The sludge filter is attached directly to the walls or floor of a container. A border of the sludge filter comprises one part of a two-part fastener system with a second part of the two-part fastener system attached to a container along the perimeter of the filter coverage area so that the filter medium be removably attached to the container. U.S. Pat. No. 9,034,010, issued on Oct. 13, 2010 to the present inventor, describes a method for filtering sludge solids from sludge liquids. This method utilizes a sludge filter comprised of a rigid, yet deformable, filter media and a support net. The support net includes a front surface adjacent the filter media and a rear surface opposite the filter media. The rear surface has a plurality of outwardly extending nodes to define flow channels for horizontal and vertical fluid flow intermediate the net.

U.S. Pat. No. 5,858,226, issued on Jan. 12, 1999 to the present inventor, describes a selectively removable gravitational and vacuum sludge filtration apparatus and method that provides for retrofit into a container and for separation of the sludge solids from the sludge liquids therein. A pair of spaced vertically oriented filter assemblies each define a filtrate cavity therein and are connected by separator plates. The filter assemblies permit the flow of sludge liquids into the filtrate cavity, but not the sludge solids. A separator divides each filtrate cavity into two cavity sections, a first filtrate cavity and a second filtrate cavity. Filtrate drains into the first and second filtrate cavities by either vacuum or gravitational drainage, depending on the level of sludge within the container. Vacuum drainage occurs in the first or second filtrate cavity if either cavity is situated below the level of sludge within the container. A first and second filtrate evacuation means provides for the evacuation of filtrate from the first and second filtrate cavities by the use of a vacuum pump. A set of fasteners hold the filter assemblies in the container and bias the filter assemblies against the container bottom. The fasteners may be released to provide for removal of the sludge filtration system from the container.

U.S. Patent Application Publication No. 2006/0011561, published on Jan. 19, 2006 to Brouillard et al., provides a mobile filtration system having a floor panel and a plurality wall panels connected to each other so as to define a box. At least one filtering wall is vertically inclined and supported inward of a corresponding wall panel so as to define a first free space therein. A filtering floor is horizontally inclined and supported above the floor panel so as to define a second free space therebetween. The filtering floor is connected to a filtering wall to define a filter chamber, a plurality of openings defined in the filtering wall. The filtering floor is sized to let a liquid pass through and retain at least one target solid within the filter chamber.

U.S. Patent Application Publication No. 2010/0206817, published on Aug. 19, 2010 to D. D. Dieziger, shows a settling tank for dewatering a thin slurry provided in a lined portable container. The settling tank is transported and dumped without requiring the transferring of residue sludge or the cleaning of equipment. This sludge is processed by settlement of the solid phase and removal of the liquid phase in cycles so as to avoid the clogging of the filter.

U.S. Patent Application Publication No. 2010/0243575, published on Sep. 30, 2010 to C. J. Nowling, teaches a separation system for separating solid-liquid mixture. A polymer solution is mixed and combined with the solid-liquid mixture to flocculate the solid-liquid mixture. The solid flocculated solid-liquid mixture is then flowed into the separation apparatus. A liquid-permeable filtration member is disposed over the floor, one or more exterior walls, and any interior dividing wall for retaining solid media within the apparatus while permitting liquids to pass. A controllable distribution system having a plurality of individually actuatable inlets is oriented to provide the solid-liquid mixture to discrete areas and to selectively maximize the efficiency of the separation process.

It is an object of the present invention to provide a sludge dewatering system that utilizes vertical filtering of the sludge.

It is also an object of the present invention to provide a sludge dewatering system that avoids the problems associated with bottom filters, such as clogging and cake sticking.

It is an object of the present invention to provide a sludge dewatering system which avoids standing water on the cake.

It is another object of the present invention to provide a sludge filtration system that increases the usable area of the filters.

It is another object of the present invention to provide a sludge filtration system that has an additional filtration surface area.

It is another object of the present invention to provide a sludge filtration system which results in a drier cake.

It is another object of the present invention to provide a sludge filtration system that facilitates the dumping of the cake.

It is another object of the present invention to provide a sludge filtration system that has an adjustable inlet flow distribution.

It is another object of the present invention provide a sludge filtration system that has a non-stick and abrasion-resistant surface that facilitates the ability of the cake to slide out of the container.

It is another object of the present invention to provide a sludge filtration system that protects the floor of the container.

It is still another object of the present invention provide a sludge filtration system which allows water to pass unimpeded to the drain holes.

It is still further object of the present invention provide a sludge filtration system that avoids dumping water in violation of landfill regulations.

These and other objects and advantages of the present invention will become apparent from a reading of the attached specification and appended claims.

### BRIEF SUMMARY OF THE INVENTION

The present invention is a sludge dewatering system that comprises a container having an interior volume and a floor and a plurality of filtration panels positioned in the interior volume of the container. Each of the plurality of filtration panels has an expanded metal panel, a filter media extending along a surface of the expanded metal panel, and a frame affixed against the filter media and the expanded metal panel. The expanded metal panel can be a perforated plate or other type of porous filter support panels. The filter media has a portion extending outwardly beyond the bottom of the frame. This portion extends outwardly against the floor of the container. Optionally, a plastic panel overlies the portion of the filter media and resides over a portion of the floor of the container.

The container has a pair of side walls and a pair of end walls extending between the pair of side walls. The plurality of filtration panels, in one embodiment, comprises a first filtration panel extending in parallel relation to the pair of side walls and a second filtration panel extending in parallel relation to the pair of side walls. The first and second filtration panels are evenly spaced from the pair of side walls. In another embodiment, the plurality of filtration panels can include a center filtration structure positioned between the pair of side walls. The first and second filtration panes are on opposite sides of the center filtration structure.

The plastic panel comprises a first plastic panel positioned between one of the pair of side walls and the first filtration panel, a second plastic panel position between the first and second filtration panels, and a third plastic panel position between the second filtration panel and another of the pair of side walls. A third filtration panel can be affixed against one of the pair of side walls and a fourth filtration panel can be affixed against another of the pair of side walls.

The frame comprises a top bar, pair of side bars affixed to an extending downwardly from the top bar, and a lower bar extending between the pair of side bars. The lower bar is positioned above the bottom of the pair of side bars. The portion of the filter media extends beyond the bottom of the pair of side bars. The portion of the filter media is bent by approximately 90° from the remainder of the filter media. The portion of the filter media is interposed between the floor of the container and a bottom of the plastic panel. The floor of the container has a stud extending upwardly therefrom. The plastic panel has a hole that receives the stud therein so as to fix a position of the plastic panel against the floor of the container. The frame has an area wherein the filter media is fully exposed at the bottom of the frame.

The container has a plurality of channels respectively underlying the plurality of filtration panels. The floor of the container has drain holes communicating with the plurality of channels. In one embodiment of the present invention, the plurality of filtration panels define at least three sludge-receiving chambers within the container. In another embodiment, the plurality of filtration panels defines two sludge-receiving chambers within the container.

One of the pair of end walls is hingedly connected to the container so as to be openable such that the sludge can be discharged outwardly from the container. The end wall has a sludge inlet thereon. The sludge inlet communicates with the interior of the container. The sludge inlet includes at least a first sludge inlet communicating with the space between the side wall of the container and one of the plurality of filtration panels, and a second sludge inlet communicating with a space between another of the plurality of filtration panels and another side wall of the container. Each of the sludge inlets has a throttling valve thereon. The throttling valve controls the flow of the sludge into the interior of the container. An inlet manifold is connected to the sludge inlets. The inlet manifold is connected to the sludge inlets by a swivel fitting. The manifold is in swingable relation to the end of the container. The manifold has a shut-off valve thereon.

This foregoing Section is intended to describe, with particularity, the preferred embodiment of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is an upper perspective view showing one embodiment of the sludge dewatering system of the present invention.

FIG. 2 is an end view of the sludge dewatering system of the present invention.

FIG. 3 is an upper perspective view of a portion of the sludge dewatering system of the present invention showing, in particular, the relationship of the filtration panels and the plastic panels.

FIG. 4 is an end view showing the relationship between the filter media, the frame and the floor of the container.

FIG. 5 is an end view showing the placement of the plastic panel over a portion of the filter media at the floor of the container of the sludge dewatering system of the present invention.

FIG. 6 is a perspective view showing support structure for the sludge dewatering system of the prior art.

FIG. 7 is an upper perspective view showing the support structure for the sludge dewatering system of the present invention.

FIG. 8 is a frontal view showing the filtration panel of the prior art.

FIG. 9 is frontal view showing the filtration panel of the present invention.

FIG. 10 is an end view of the sludge dewatering system of the present invention showing, in particular, the sludge inlets.

### DETAILED DESCRIPTION OF THE INVENTION

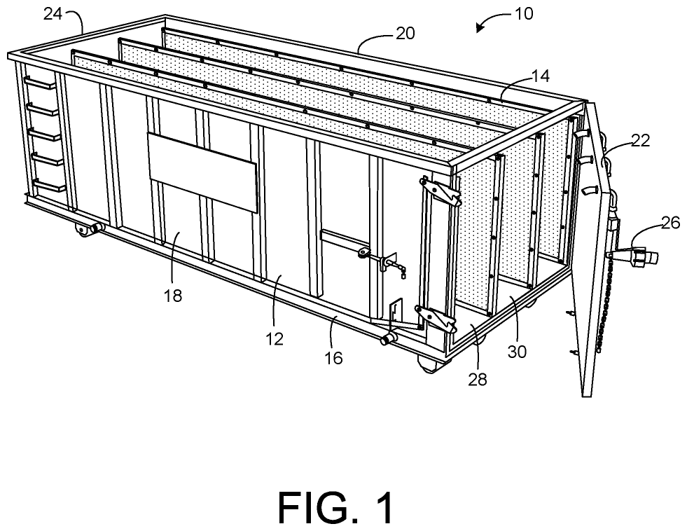

Referring to FIG. 1, there is shown the sludge dewatering system 10 of the present invention. The sludge dewatering system 10 includes a container 12 having an open top 14 and a floor 16. In particular, the container 12 has side walls 18 and 20 and end walls 22 and 24. End wall 22 is illustrated as being hingedly connected to the container 12 so as to open and close. FIG. 1 shows the end wall 12 in the open position so as to allow the contents in the interior 14 of the container 12 to be dumped or removed therefrom. The sludge inlet 26 is illustrated as affixed to the end wall 22. Sludge inlet 26 is adapted to deliver sludge into the interior 14 of the container 12.

In FIG. 1, it can be seen that filtration panels 28 and 30 extend upwardly from the floor 16 of the container 12. Filtration panels 28 and 30 are illustrated as extending for almost the entire height of the container 12. The filtration panels 28 and 30 are illustrated are evenly spaced from the side walls 18 and 20 of the container 12. Similar filtration panels can be affixed to the inner sides of the side walls 18 and 20. The sludge dewatering system 10 is adapted to be suitably placed on a bed of a truck for delivery to a landfill. This system can also be used on trailer-mounted and tipping-stand-mounted units. Within the concept of the present invention, the plurality of filtration panels can include a central filtration structure positioned centrally of the container in which the filtration panels are on opposite sides of the central filtration structure.

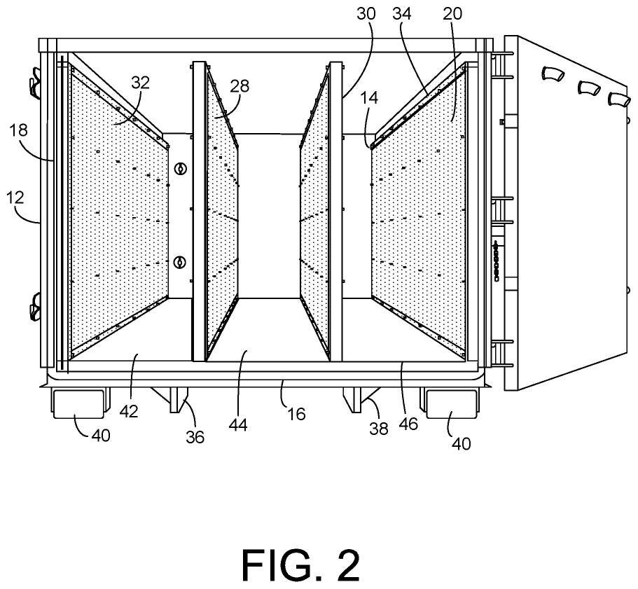

FIG. 2 shows, in particular, the interior 14 of the container 12. In particular, FIG. 2 shows the floor 16 and the filtration panels 28 and 30 extending vertically upwardly from the floor 16. The side wall 18 is illustrated as having a filtration panel 32 thereon. Similarly, side wall 20 is illustrated as having another filtration panel 34 thereon. Importantly, filtering will occur on each side of the filtration panels 28 and 30. As will be described hereinafter, each of the filtration panels includes, at least, a porous panel (or expanded metal panel), a filter media extending along the surface of the expanded metal panel, and a frame affixed against the filter media and the expanded metal panel. This configuration is known in the prior art and has been adapted, in the past, for the filtering of water from sludge. Ultimately, the water that has been filtered from the sludge will pass into channels 36 and 38 located at the floor 16 of the container 12. Channels 36 and 38 allow the water to be ultimately drained from the container 12. Rollers 40 are provided at the floor 16 of the container 12 so as to allow the container 12 to slide onto and off of the bed of a truck.

FIG. 2 further shows a unique feature of the present invention. In particular, there is a plastic panel 42 is positioned on the floor 16 between the filtration panel 28 and the filtration panel 32. Another plastic panel 44 is positioned between the filtration panel 28 and the filtration panel 30. Another plastic panel 46 is positioned on the floor 16 between the filtration panel 30 and the filtration panel 34. Plastic panels 42, 44 and 46 will extend for the length of the floor 16. As will be described hereinafter, the plastic panels 42, 44 and 46 serve to secure a lower end of the filter media and to allow for the accumulation of the sludge cake thereon.

In particular, as will be described hereinafter, the filter media of the filtration panels 28, 30, 32, and 34 will make a 90° turn at the floor 16 of the container 12 so as to leave no standing water in the cake. This 90° corner will also increase the usable area of the filtration panels so as to provide additional filtration surface area. The use of the filtration panels 28 and 30 in the container 12 increases the filtration area by 33% over containers that have only one center filter wall. This increased filter surface area and the more narrow sludge compartments formed by the additional filter wall will translate into drier cakes that are formed in less time. The plastic panels 42, 44 and 46 will serve to facilitate the dumping of the cake. Experiments with the present invention have shown that the filter cake will flow outwardly of the container 12 very smoothly because of the use of the plastic surfaces on the plastic panels 42, 44 and 46. The sludge filtration system of the present invention is particularly adapted for bio-solids dewatering, manufacturing waste, grease trap waste, septic tank sludge, industrial sludge, mining sludge, and alum sludge. The system of the present invention can also be used without the plastic panels 42, 44 and 46. The 90° corner of the filter can be utilized with the expanded metal panel or porous panel with a raised flat bar. Studs are located on the floor going through the filter. A flat bar on top of that will hold down the edge. As such, the goals of the present invention could be accomplished without the plastic panels.

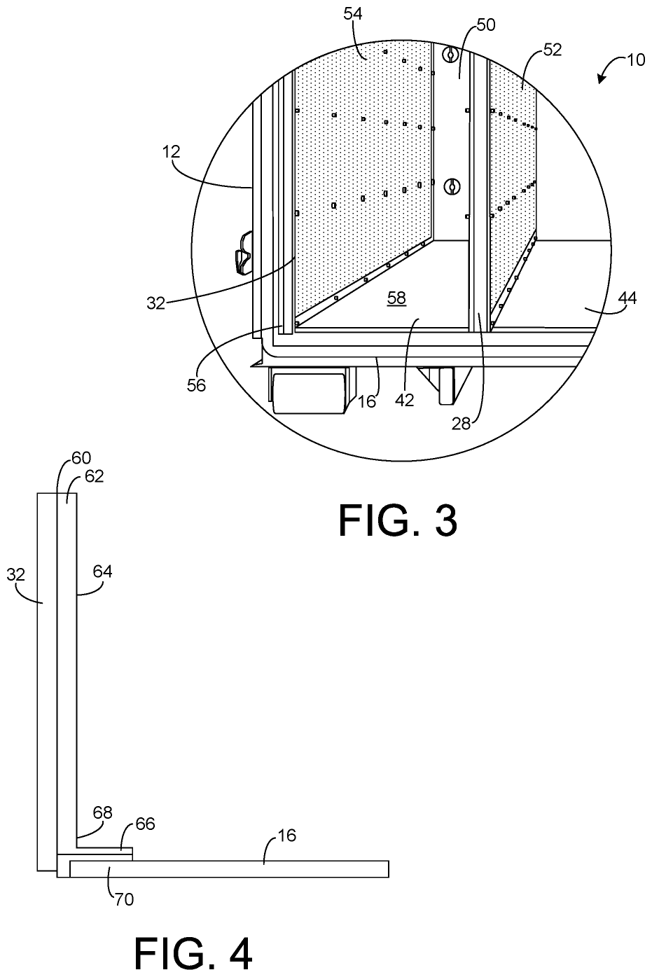

FIG. 3 shows a close-up view of a corner of the sludge filtration system 10 of the present invention. In particular, FIG. 3 shows that the floor 16 of container 12 has filtration panels 32, 32 and 28 extending upwardly therefrom. Plastic panel 42 is positioned on floor 16 between the filtration panels 32 and 34. Another plastic panel 44 will extend along the floor 16 on the opposite side of the filtration panel 28. Ultimately, in the present invention, the filter media will be on side 50 and side 52 of the filtration panel 28. The filter media 54 will be on only the interior side of the filtration panel 32. The plastic panels 42 and 44 replaces the volume where water could stand at the bottom of the container 12. These plastic panels 42 and 44 also offer a non-stick and a abrasion-resistant surface. This allows the cake to slide out of the container 12 when unloading the container. In additionally, the plastic panels 42 and 44 will protect the floor 16 of the container 12 from damage. If the plastic panels 42 and 44 should become damaged, then they can be easily replaced.

It is important to note in FIG. 3 that there is a sharp 90° corner 56 formed between the filtration panel 32 and the plastic panel 42. The filter media 54 is shown as extending all the way down to the top surface 58 of the plastic panel 42. As such, any water that would pool on the top surface 58 of the plastic panel 42 will flow directly into the filtration panel 32. There is no metal frame or other obstructions that would block this flow or otherwise cause the accumulation of water into the area on the top surface 58 of the plastic panel 42. A similar sharp 90° corner also appears between the plastic panel 42 and the filtration panel 28.

FIG. 4 illustrates the relationship between the floor 16 of the container and the filtration panel 32. The filtration panel 32 includes an porous panel 60, filter media 62 and a frame 64. It can be seen that the filter media 62 has a portion 66 that extends beyond the bottom 68 of the frame 64. This portion 66 will extend at a 90° angle with respect to the remainder of the filter media 62 and with respect to the frame 64 so as to overlie the floor 16. The sponge gasket 70 can be interposed between the floor 16 and the portion 66 of the filter media 62. The porous panel 60 can be an expanded metal panel.

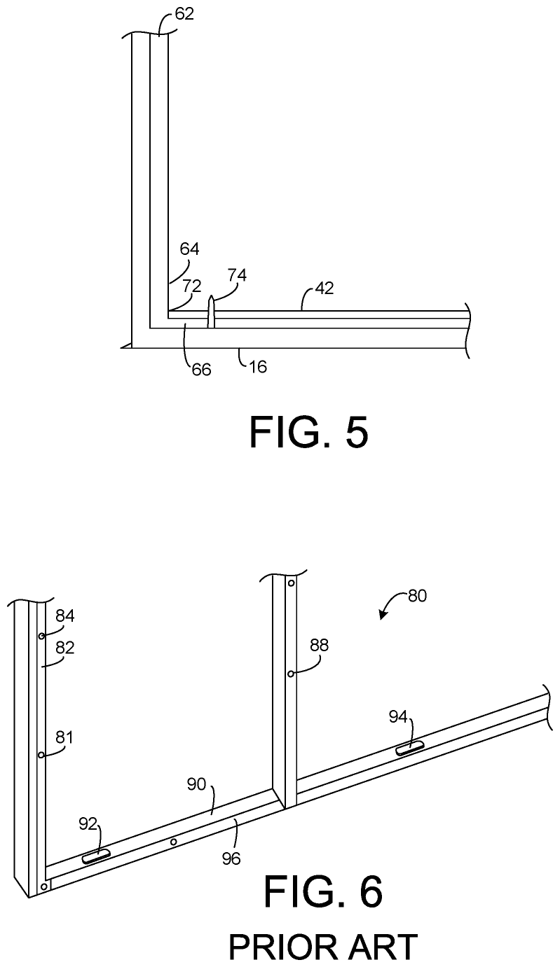

FIG. 5 illustrates a further step in the construction of the sludge dewatering system of the present invention. In particular, in FIG. 5, it can be seen that the plastic panel 42 will overlie the portion 66 of the filter media 62. The edge 72 of the plastic panel 42 will reside against a lower portion of the side bars of the frame 64. A plurality of studs 74 extend upwardly from the floor 16. The plastic panel 42 will have a plurality of holes that serve to receive the studs 74 therein. The studs 74 retain the plastic panel 42 in its position on the floor 16.

As will be described hereinafter, the filter media 62 of the present invention has a portion that extends beyond the lower level of the frame. As such, because of this extended length of the filter media, it is important to be able to retain the filter media within the container. As such, the plastic panel 42 will overlie this extended length of the filter media so as to effectively retain the filter media on the floor 16 in a proper position. Any water that wants to settle in the bottom of the container now has a clear path to the drain holes.

FIG. 6 shows the frame of a prior art sludge dewatering system 80. As can be seen, this frame includes angle iron 82 welded to the wall of the container. Angle iron 82 will include bolt holes 84 and 86 thereon. Another frame 88 is also welded to the wall of the container and will generally extend out approximately three inches from the wall. A flat bar 90 is welded to the floor of the container. Typically, the flat bar will have a thickness of approximately two inches. Drain holes 92 and 94 are formed through the flat bar 90. The angle iron 82 and the frame 88 will be affixed to the flat bar 90 and extend upwardly therefrom. The surface 96 of the flat bar 90 of the prior art shown in FIG. 6 will form a dam at the floor of the container so as to trap water thereagainst. As such, any water from the sludge that does not pass outwardly through the drain holes 92 and 94 will reside on the floor of the container by the surface 96 of the support structure shown in FIG. 6.

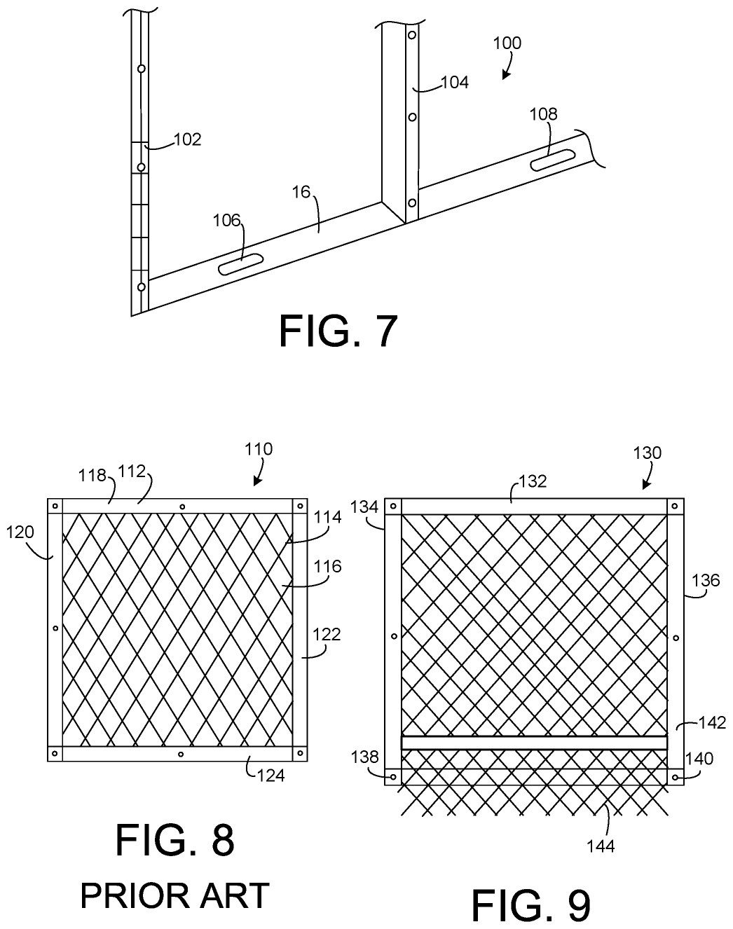

FIG. 7 shows the support structure 100 of the present invention. In particular, the angle iron 102 and the frame 104 extend directly upwardly from the floor 16. The drain holes 106 and 108 are formed through the floor of the container. As such, there inherently will be no surface similar to surface 96 of FIG. 6 that creates a dam to prevent water flow to the drain holes 106 and 108.

FIG. 8 shows the filtration panel 110 of the prior art. Filtration panel 110 has a frame 112 in which an expanded metal panel 114 and a filter media 116 are retained. The frame 112 has a top bar 118 and side bars 120 and 122 extending downwardly from opposite ends of the top bar 118. The lower bar 124 is joined to the bottom ends of the side bars 120 and 122. As such, the square frame-like structure serves to retain the expanded metal panel 114 and the filter media 116 therein. Unfortunately, since the lower bar 124 is located at the bottom of the filter media 116, this lower bar 124 will serve to further block fluid flow into the filter media 116 and therefore create a dam to water flow.

FIG. 9 shows the filtration panel 130 as used in the present invention. Filtration panel 130 includes a top bar 132 and side bars 134 and 136. The side bar 134 has a bottom end 138. The side bar 136 has a bottom end 140. In FIG. 9, it can be seen that the lower bar 142 is positioned well above the bottoms 138 and 140 of side bars 134 and 136, respectively. The filter media 144 will extend outwardly below the lower bar 142. It is this portion of the filter media 144 that will bend 90° inwardly so as to be positioned between the plastic panel and the floor of the container. Since the lower bar 142 is spaced above the bottoms 138 of 140 of the side bars 134 and 136, respectively, the lower bar 142 will not block fluid flow through the filter media 144 and ultimately into the drain. As such, this configuration facilitates water flow within the sludge dewatering system of the present invention and avoids the pooling of water.

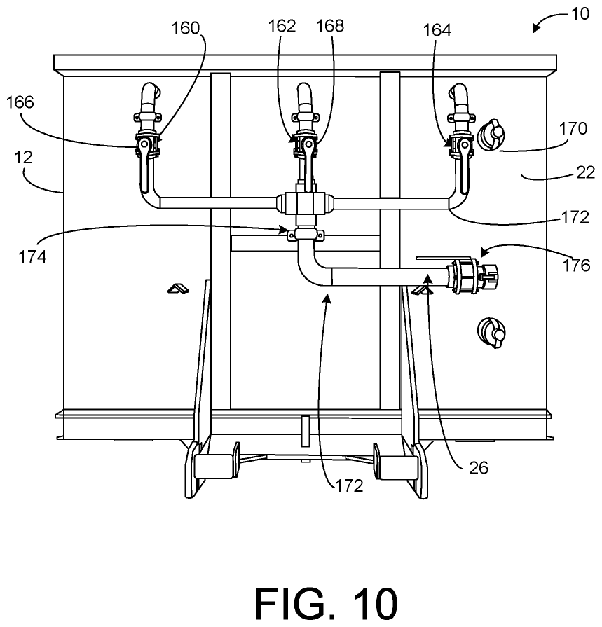

FIG. 10 shows an end view of the sludge dewatering system 10 of the present invention. In particular, end 22 of container 12 is particularly illustrated. FIG. 10 shows the sludge inlet 26 used for the delivery of sludge into the interior of the container 12. The sludge inlet 26 includes a first sludge inlet 160, a second sludge inlet 162 and a third sludge inlet 164. Sludge inlets 160, 162 and 164 open to the interior 14 of the container 12 so as to deliver sludge independently into each of the chambers defined on the interior 14 of the container 12. These chambers are defined by the space between side wall 18 and the first filtration panel 28, the space between the first filtration panel 28 and the second filtration panel 30, and the space between the second filtration panel 30 and the side wall 20. The first sludge inlet 160 has a throttling valve 166 thereon. Second sludge inlet 162 has a throttling valve 168 thereon. Third sludge inlet 164 has a throttling valve 170 thereon. Throttling valves 166, 168 and 170 control the flow of the sludge into the interior of the container. An inlet manifold 172 is connected to the first sludge inlet 160, the second sludge inlet 162 and the third sludge inlet 164. In particular, a swivel fitting 174 supports the manifold 162 in its connection to the sludge inlets. The manifold 172 is connected to the sludge inlet 26. Sludge inlet 26 has a shutoff valve 176 thereon.

The sludge inlet 26 of the present invention controls the flow of sludge into the container 12. The flow can be evenly distributed into the three internal chambers by operating the throttle valves installed on the inlet manifold 172. The shutoff valve 176 at the end of the manifold is closed when disconnecting the sludge feedline. The serves to prevent spills. A groove-type clamp attaches the inlet arm to the main manifold and allows the arm to swing to either side so as to facilitate the ability of the present invention to adapt to the location of sludge feed. When a single central filtration structure is used, the sludge inlets will open to chambers formed on opposite sides of the control filtration structure. Whenever a single central filtration structure is used, there would be only one inlet. The system would have only one inlet. When two center filter panels are used, there are a total of three inlets and valves associated therewith.

The foregoing disclosure and description of the invention is illustrative thereof. Various changes in the details of the illustrated construction can be made is the scope of the present claims without departing from the true spirit of the invention. The present invention should only be limited by the following claims and their legal equivalents.

I claim:

1. A sludge dewatering system comprising:
a container having an interior volume and a floor; and
a plurality of filtration panels positioned in the interior volume of said container, each of said plurality of filtration panels comprising:
a porous panel; and
a filter media extending along a surface of said porous panel, said filter media having a portion extending outwardly beyond a bottom of said frame, the portion extending outwardly so as to reside generally against the floor of said container.

2. The sludge dewatering system of claim 1, further comprising:
a plastic panel overlying the portion of said filter media and residing over a portion of the floor of said container.

3. The sludge dewatering system of claim 2, said container having a pair of side walls and a pair of end walls extending between the pair of side walls, the plurality of filtration panels comprising:
a first filtration panel extending in parallel relation to said pair of side walls; and
a second filtration panel extending in parallel relation to said pair of side walls.

4. The sludge dewatering system of claim 3, said first and second filtration panels being equally spaced from each other and from the pair of side walls.

5. The sludge dewatering system of claim 3, said first and second filtration panels being on opposite sides of a central filtration structure.

6. The sludge dewatering system of claim 3, said plastic panel comprising:
a first plastic panel positioned between one of the pair of side walls and said first filtration panel;
a second plastic panel positioned between the first and second filtration panels; and
a third plastic panel positioned between said second filtration panel and another of the pair of side walls.

7. The sludge dewatering system of claim 3, further comprising:
a third filtration panel affixed against one of the pair of side walls; and
a fourth filtration panel affixed against another of the pair of side walls.

8. The sludge dewatering system of claim 1, said frame comprising:
a top bar;
a pair of side bars affixed to and extending downwardly from said top bar, each of said pair of side bars having a bottom end; and
a lower bar extending between said pair of side bars, said lower bar positioned above the bottom of said pair of side bars.

9. The sludge dewatering system of claim 8, the portion of said filter media extending beyond the bottom of said pair of side bars.

10. The sludge dewatering system of claim 1, the portion of said filter media being bent by 90° from a remainder of said filter media.

11. The sludge dewatering system of claim 2, the portion of said filter media being interposed between the floor of said container and a bottom of said plastic panel.

12. The sludge dewatering system of claim 11, the floor of said container having a stud extending upwardly therefrom, said plastic panel having a hole that receives the stud therein so as to fix a position of the plastic panel against the floor of said container.

13. The sludge dewatering system of claim 1, said frame having an area wherein the filter media is fully exposed at a bottom of said frame.

14. The sludge dewatering system of claim 1, said container having a plurality of channels underlying said plurality of filtration panels respectively, the floor of said container having drain holes communicating with the plurality of channels.

15. The sludge dewatering system of claim 1, said plurality of filtration panels defining at least two sludge receiving chambers in said container.

16. The sludge dewatering system of claim 3, one of the pair of end walls being hingedly connected to said container so as to be openable such that sludge can be discharged outwardly from the interior of said container.

17. The sludge dewatering system of claim 3, one of said pair of end walls having a sludge inlet thereon, the sludge inlet communicating with the interior of said container.

18. The sludge dewatering system of claim 17, the sludge inlet comprising:
at least one first sludge inlet communicating with a space between a side wall of said container and one of said plurality of filtration panels; and
at least one second sludge inlet communicating with the space between another of the plurality of filtration panels and another side wall of said container.

19. The sludge dewatering system of claim 18, each of said at least one first sludge inlet and said second sludge inlet having a throttling valve thereon, the throttling valve controlling a flow of the sludge into the interior of said container.

20. The sludge dewatering system of claim 18, further comprising:
an inlet manifold connected to said first sludge inlet and said second sludge inlet.

21. The sludge dewatering system of claim 19, said manifold being swingable relative to the end of said container, said manifold having a shut-off valve thereon.
